(19) United States
(12) Patent Application Publication
(10) Pub. No.: US 2022/0253876 A1
(43) Pub. Date: Aug. 11, 2022

(54) PATH FINDING ANALYTIC TOOL FOR CUSTOMER DATA

(71) Applicant: Amdocs Development Limited, Limassol (CY)

(72) Inventor: Roy Darnell, Rehovot (IL)

(21) Appl. No.: 17/174,181

(22) Filed: Feb. 11, 2021

(51) Int. Cl. G06Q 30/02; G06T 17/05

(52) U.S. Cl. CPC G06Q 30/0205; G06Q 30/0201; G06T 17/05

(57) ABSTRACT

A system, method, and computer program are provided for a path-finding analytic tool that operates on customer data. In use, customer data that includes a plurality of customer profiles stored for a plurality of customers of a business entity is accessed. Each customer profile includes values for: one or more non-actionable features, and one or more actionable features. At least a 3D map is generated from the customer data, where each point on the map represents a different customer profile, and where at least one dimension of the map represents a target feature. A path is determined between a first point on the map representing a first customer profile and a second point on the map representing a second customer profile, for identifying at least one actionable feature in the first customer profile capable of having its value modified to optimize the target feature corresponding to the first customer profile.

### FIELD OF THE INVENTION

The present invention relates to techniques for analyzing customer data.

### BACKGROUND

Business entities generally collect large amounts of diverse data on their customers and store the data in customer profiles. This data can include demographic-related information, such as age, gender, residence location, etc. of the customer, as well as business-related information, such as service subscriptions, product purchases, offers made, prior customer-service interactions, etc. This customer data is valuable to business entities as it can be useful for making business decisions to increase profitability, customer satisfaction, etc.

Unfortunately, the analytic tools available to business entities for analyzing their customer data have been limited. For example, current analytic tools usually summarize customer data in simple formats, such as text or two-dimensional (2D) charts for use by humans in making business-related assumptions, decisions, etc. In some cases, current analytic tools may employ artificial intelligence (AI) to make predictions based on the customer data, but do not explain the underlying data supporting the predictions.

There is thus a need for addressing these and/or other issues associated with the prior art.

### SUMMARY

As described herein, a system, method, and computer program are provided for a path-finding analytic tool that operates on customer data. In use, customer data that includes a plurality of customer profiles stored for a plurality of customers of a business entity is accessed. Each customer profile of the plurality of customer profiles includes values for: one or more non-actionable features that are each a feature that is not capable of being affected by the business entity, and one or more actionable features that are each a feature that is capable of being affected by the business entity. At least a three-dimensional (3D) map is generated from the customer data, where each point on the map represents a different customer profile of the plurality of customer profiles, and where at least one dimension of the map represents a target feature. A path is determined between a first point on the map representing a first customer profile of the plurality of customer profiles and a second point on the map representing a second customer profile of the plurality of customer profiles, for identifying at least one actionable feature of the one or more actionable features in the first customer profile capable of having its value modified to optimize the target feature corresponding to the first customer profile.

### BRIEF DESCRIPTION OF THE DRAWINGS

FIG. 1 illustrates a method for a path-finding analytic tool that operates on customer data, in accordance with one embodiment.

FIG. 2 illustrates a method for generating a four-dimensional (4D) map from customer data, in accordance with one embodiment.

FIGS. 3A-D illustrate user interfaces of a path-finding analytic tool, in accordance with one embodiment.

FIG. 4 illustrates a network architecture, in accordance with one possible embodiment.

FIG. 5 illustrates an exemplary system, in accordance with one embodiment.

### DETAILED DESCRIPTION

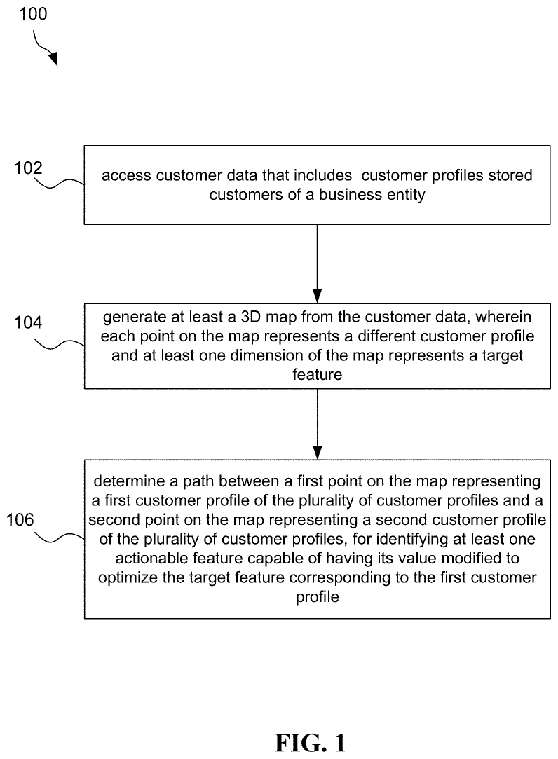

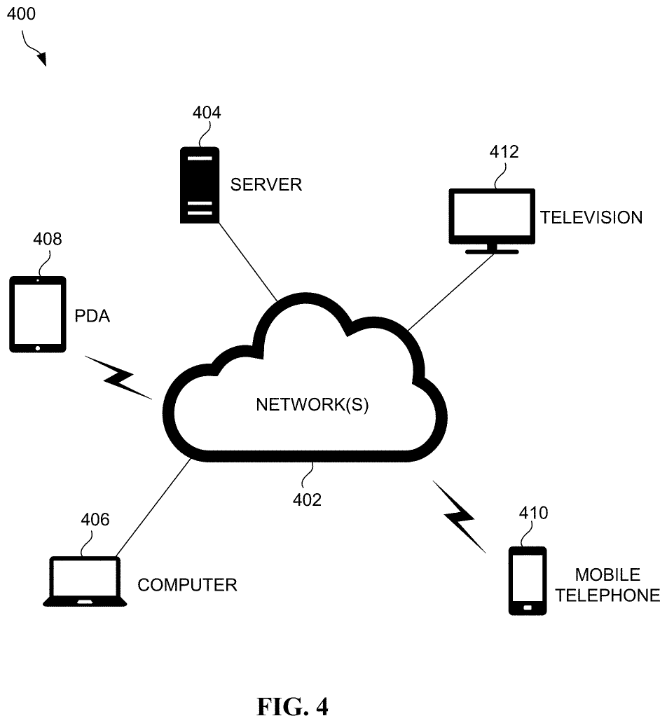

FIG. 1 illustrates a method 100 for a path-finding analytic tool that operates on customer data, in accordance with one embodiment. The method 100 may be performed any computer system described below with respect to FIGS. 4 and/or 5. For example, the method 100 may be performed by a computer system or combination of computer systems implemented as an echo system.

In operation 102, customer data that includes a plurality of customer profiles stored for a plurality of customers of a business entity is accessed. Each customer profile of the plurality of customer profiles includes values for: one or more non-actionable features that are each a feature that is not capable of being affected by the business entity, and one or more actionable features that are each a feature that is capable of being affected by the business entity.

The customer data may be accessed from any storage location(s) storing the customer data. For example, the customer data may be stored in one or more databases of the business entity. The business entity may be a telecommunications service provider, for example, or any other business entity offering products and/or servicers to customers.

As noted above, each customer profile includes values for parameters relating to non-actionable features and actionable features. The non-actionable features may be an age of the customer, a gender of the customer, a location of a residence of the customer, a size of family of the customer, an income of the customer, and/or hobbies of the customer, for example. The actionable features may be offers made to the customer by the business entity (e.g. products or services offered to the customer by the business entity), a time (e.g. date) that each of the offers was made to the customer, an indication of whether each of the offers was accepted by the customer, and/or an indication of which of the products or services the customer currently has.

In operation 104, at least a three-dimensional (3D) map is generated from the customer data, where each point on the map represents a different customer profile of the plurality of customer profiles, and where at least one dimension of the map represents a target feature. To this end, the map is generated at least in 3D, but may also be generated as a four-dimensional (4D) map in one embodiment.

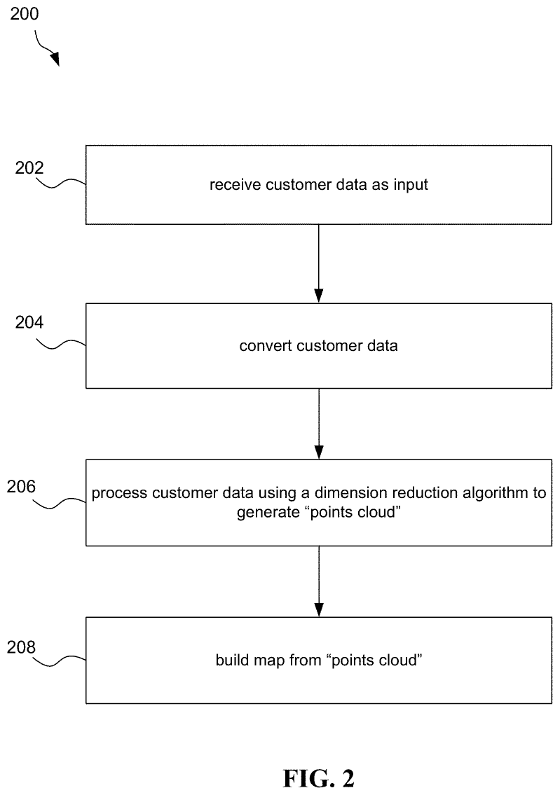

For example, generating the map may include generating a two-dimensional (2D) map of the plurality of customer profiles based on the one or more non-actionable features and the one or more actionable features, calculating a value for the target feature for each customer profile, and further generating a 3D map by adding the target feature to the 2D map. With regard to the map being 4D, the fourth dimension may represent a degree to which leading properties (of the customer profiles) are actionable, as described in more detail with reference to FIG. 2 below. As an option, generating the map may also include smoothing the 3D (or 4D) map by using extrapolation to fill in blank points on the map.

It should be noted that the target feature may refer to any feature (e.g. parameter) selected for optimization. In one embodiment, the target feature may be a customer value to the business entity. This customer value may be defined as an average revenue per user (ARPU), for example. In another embodiment, the customer value may be calculated for each customer profile of the plurality of customer profiles, using a predefined function.

In operation 106, a path is determined between a first point on the map representing a first customer profile of the plurality of customer profiles and a second point on the map representing a second customer profile of the plurality of customer profiles, for identifying at least one actionable feature of the one or more actionable features in the first customer profile capable of having its value modified to optimize the target feature corresponding to the first customer profile. The path may be determined manually (i.e. by a user) or automatically, as described below.

In one embodiment, the map may be displayed in a user interface for viewing by a user. In this embodiment, the user interface may include a path tool, where the path is determined from the user manually drawing the path on the map. Responsive to the user manually drawing the path on the map, the user interface may present the values for the non-actionable feature(s) and the actionable feature(s) for the first customer profile and the second customer profile. As a further option, the user interface may include a point tool for use by the user in selecting a point on the map, where the user interface may present the values for the non-actionable feature(s) and the actionable feature(s) for a customer profile corresponding to the selected point on the map.

In another embodiment, the path may be determined automatically using an algorithm. For example, the algorithm may generate a plurality of potential paths and select one of the potential paths as the determined path. The one of the potential paths may be selected for having a greatest change between the first point and the second point in the dimension representing the target feature with the least distance in another (e.g. predefined) dimension.

As noted above, the path is determined for identifying at least one actionable feature in the first customer profile capable of having its value modified to optimize the target feature corresponding to the first customer profile. In one embodiment, the value of the actionable feature(s) in the first customer profile may be identified as capable of being modified to match a value of the corresponding actionable feature(s) in the second customer profile. This modification may result in an optimization of the target feature corresponding to the first customer profile based on the second customer profile. Optionally, a probability of optimization may be determined, which may refer to a probability that the target feature corresponding to the first customer profile will be optimized responsive to modifying the actionable feature(s) in the first customer profile. The prediction may be determined from historical data, as described in more detail below with reference to the subsequent figures.

To this end, the method 100 may be implemented as an analytic tool that finds paths between customer profiles for the purpose of identifying modifications to those customer profiles that will optimize (e.g. improve with regard to a defined goal) a target feature. As noted above, this analytic tool may provide a 3D or 4D map that may be interactive to present underlying customer data in a manner that can be easily understood by the user.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a method 200 for generating a 4D map from customer data, in accordance with one embodiment. As an option, the method 200 may be carried out in the context of the details of the previous figure and/or any subsequent figure(s). For example, the method 200, when performed, may provide an analytic tool for customer data. Of course, however, the method 200 may be carried out in the context of any desired environment. Further, the aforementioned definitions may equally apply to the description below.

In operation 202, input is received which includes customer data. The customer data may be stored in a relational database (e.g. a csv file). The customer data includes customer profiles with values for various features. The values may be numerals, text, or in any other format.

In operation 204, the customer data is converted to numerals. Existing numeric values will remain the same, features that hold string values are split into a multiple 1 hot vector, where the original feature is split into multiple features, and where each new feature represents a unique string in the original feature. In this case, if a row has this string it gets a 1 else 0. Then, the values are normalized, and a unique index is added to each one of the indices.

Table 1 illustrates exemplary input customer data, which each row representing a customer profile and each column representing a feature.

TABLE 1

| ID | ARPU | Reg. asia |
|---|---|---|
| 345 | 43 | 1 |
| 865 | 35 | 0 |

The customer data may also include labels specified in a user interface by a user or marked in the data set. The labels include an “actionable” label defined for every feature in the customer data, indicating whether the feature is actionable (1) or not (0). An actionable feature is a feature that represents information the user (e.g. business entity) can affect. For example, the age of a client can't be affected by the business entity, however discounts or a method of contact can vary and is dependent on the decision of the business entity.

The labels also include a “target” label which indicates one of the features as the target feature. It may be possible to create a function that creates a new feature out of multiple original features, for more complex use cases. For example, the target feature may be defined to represent both the ARPU of a customer profile and the corresponding customer's region, with some logarithmic relation, for example as shown in Table 2.

TABLE 2

Func = 1.5*log(ARPU)\hat{ }3 * Reg. asia

Table 3 illustrates the target feature added to the input customer data of Table 1.

TABLE 3

| ID | ARPU | Reg. Asia | Target |
|---|---|---|---|
| 345 | 43 | 1 | 6.53 |
| 865 | 35 | 0 | 0 |

In operation 206, the labeled customer data is processed using a dimension reduction algorithm that retains the global relations, such as Principal Component Analysis (PCA) or t-Distributed Stochastic Neighbor Embedding (t-SNE). The X\Y coordinates are added per instance as new features to the original data, and the target values are returned as Z values. At this point, we have what is known as a “points cloud.”

In operation 208, a map is built from the “points cloud.” The map is built in a manner that allows a user to sample any point on the map in real time. Initially, the data is exported for every pixel in the map that is produced. This may include to go back to the data with the x\y position selected by the user and determine which are the closest points in the PCA and calculate a weighted average of them, which will cost around O(N\hat{ }3) where N is the number of instances, and will require extreme processing power in big datasets to produce a real time feel\usage.

There are many algorithms that draw terrains out of points clouds, however this is a more complex case as each point cloud carries a lot of other features other than the XYZ coordinates. Since most of the Terrain algorithms are not very efficient and the customer data is quite large (e.g. many Gigs of raw data in each database), a new approach is required to improve the processing time.

One embodiment of this new approach involves “bucketing”, which runs once in O(N*K) where N is the amount of instances and K is the amount of features. And then every sample of the user will run in O(1). Based on the required map resolution (to be exported eventually to the user interface, for example 512×512 pixels), a tensor (“a matrix of buckets”) is built in the size of the resolution where each cell contains a vector in the size of the features in the database with a counter, an accumulated average, and an accumulated variance.

For every instance, the values of the closest cell in the tensor is updated. For example, if a row\instance in the original table got in the PCA x=112.45678, y=345.987654, the the values of cell (112,345) would be updated in the tensor (using the counter\average and variance accumulated).

An embodiment may require to fill in the gaps, namely all of the cells which got 0 in the counter after the “bucketing process.” To do that, a 3 dimensional polynomial regression model may be trained for every feature, using the accumulated averages and variances in the buckets, and the values of the blank cells may be extrapolated from the model. The result is a full tensor, which represents a 3D terrain.

In an embodiment, a 4th dimension of color may be created, that will represent areas which are actionable and areas that are not actionable. For every bucket in the matrix, the features may be sorted from low variance to high. It is assumed (when using PCA it is explicit) that features with low variance in a bucket are an accurate representation of what makes a customer profile different than other customer profiles on the map. The top m (some constant) leading features are selected and its color is defined according to the ratio of actionable to non-actionable features. For example, a customer profile with 10 out of 10 actionable leading features will be colored bright green, while the opposite (10/10 non-actionable) will be bright red, and anything in between will be somewhere on that color scale.

The result of adding the 4^{th} dimension is a 4D map that can be presented to a user and interacted with by the user.

As another option, the 4D map can be provided to an algorithm which will search for paths automatically. In this scenario, j (constant) random points may be selected on the terrain. In every iteration a gradient is calculated for every point in regard to the target feature and the color map, and then “climb uphill in the greenest direction” i steps (constant), until a local maximum is reached. This way multiple paths are drawn and those who climb the most in the least amount of steps that runs on green terrain may be chosen, with the biggest difference in the target feature (the steepest climbs). Of course there are many other optimized algorithms that are suited for this exact task (of finding local maximums), e.g. simplex.

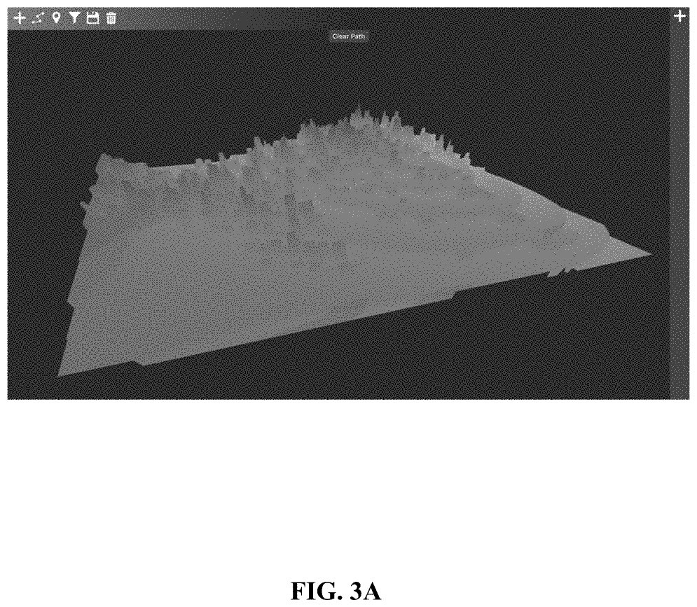

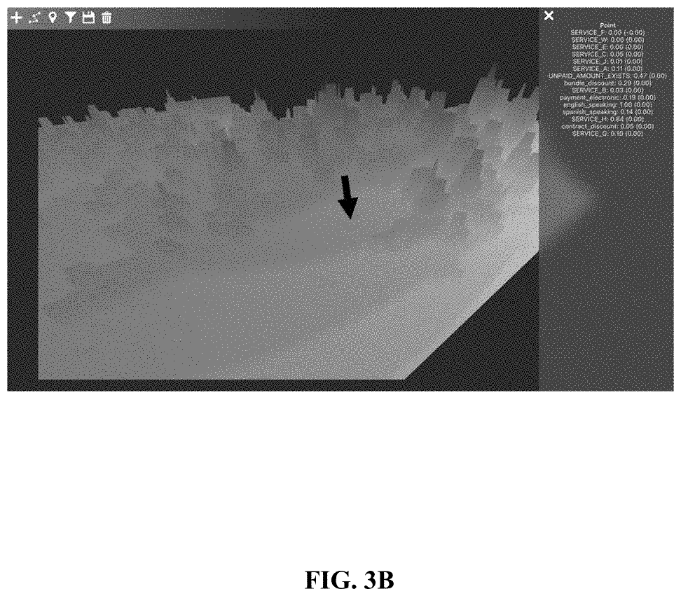

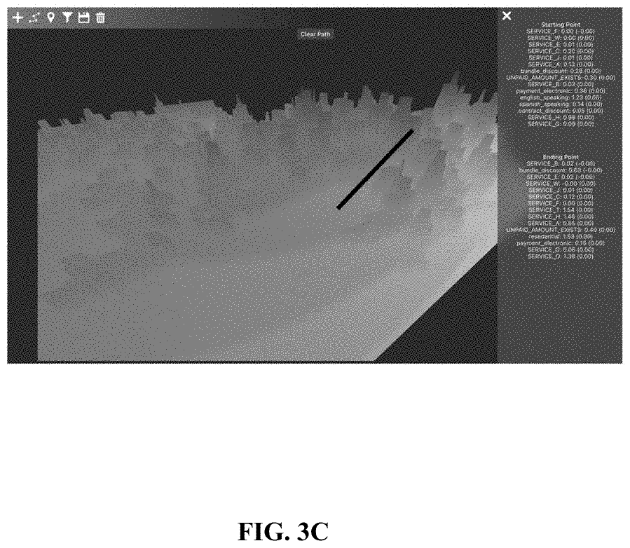

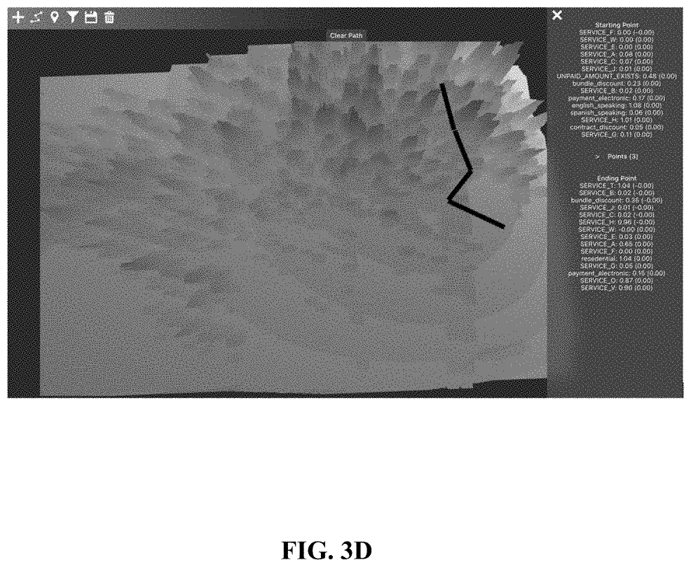

FIGS. 3A-D illustrate user interfaces of a path-finding analytic tool, in accordance with one embodiment. As an option, the user interfaces may be implemented in the context of the details of the previous figures and/or any subsequent figure(s). For example, the user interfaces may be components of the analytic tool described above. Of course, however, the user interfaces may be implemented in the context of any desired environment. Again, the aforementioned definitions may equally apply to the description below.

The path-finding analytic tool provides various interactive tools for use by a user when viewing the map. FIG. 3A illustrates a user interface presenting the map for viewing by a user. FIGS. 3B-D illustrate use of the interactive tools, as described below.

“Point tool”—Sample a point on the map. See FIG. 3B. When a point on the map is selected, the features of the customer profile corresponding to that point are presented.

“Path tool”—Lets the user draw a path on the map, showing the starting point, and ending point as well as highlighting the differences between them. See FIG. 3C.

“Auto path tool”—Uses an algorithm to suggest steep paths (from low to high) that run over green areas. See FIG. 3D which illustrates multiple paths.

“Predict path”—Given relevant historical data of actions taken by the business entity, it can be predicted how likely a path is to take place based on these past examples. For example, in an embodiment the map represents telecommunication customers and the business entity is a telecommunication service provider that wants to offer the customers bundles (of services). In this case, it is likely that the business entity already suggested various bundles to various customers. Assuming a path is found that suggests to offer 30 year old people a bundle of a particular service and 4 Gigs of data, it can be checked whether these transactions\suggestions happened in the past and it can be reported how likely these actions are, for example this bundle was a total failure (1% of the people took that offer) however, 95% of the people who are 30 years old took them, which makes it nontrivial valuable information.

“Export tool”—Exports the path data to a file for additional external processing.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

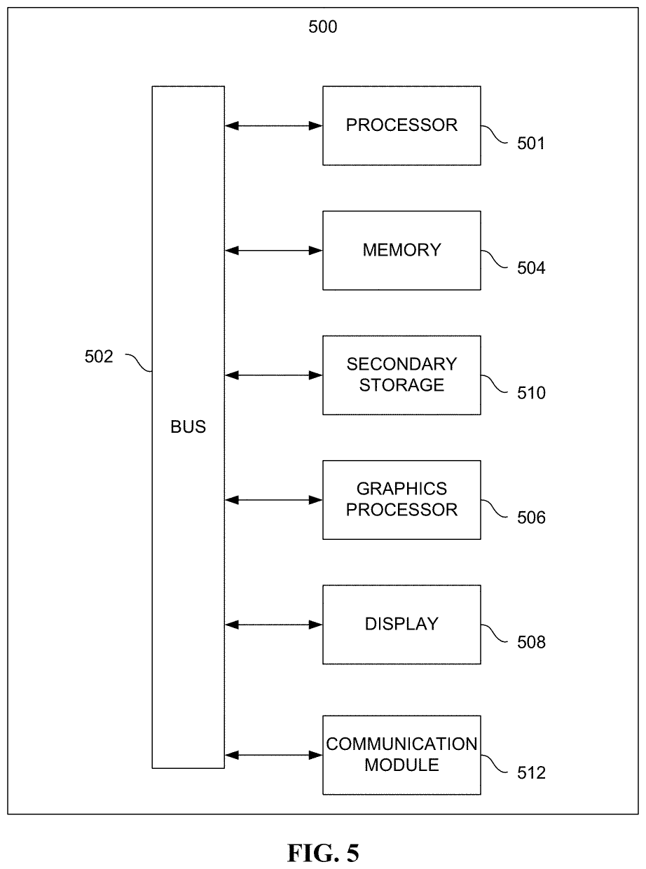

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer readable medium storing computer code executable by a processor to perform a method comprising:
accessing customer data that includes a plurality of customer profiles stored for a plurality of customers of a business entity, wherein each customer profile of the plurality of customer profiles includes values for:
one or more non-actionable features that are each a feature that is not capable of being affected by the business entity, and
one or more actionable features that are each a feature that is capable of being affected by the business entity;
generating at least a three-dimensional (3D) map from the customer data, wherein each point on the map represents a different customer profile of the plurality of customer profiles, and wherein at least one dimension of the map represents a target feature; and
determining a path between a first point on the map representing a first customer profile of the plurality of customer profiles and a second point on the map representing a second customer profile of the plurality of customer profiles, for identifying at least one actionable feature of the one or more actionable features in the first customer profile capable of having its value modified to optimize the target feature corresponding to the first customer profile.

2. The non-transitory computer readable medium of claim 1, wherein the one or more non-actionable features include at least one of: an age of the customer, a gender of the customer, a location of a residence of the customer, a size of family of the customer, an income of the customer, or hobbies of the customer.

3. The non-transitory computer readable medium of claim 1, wherein the one or more actionable features includes offers made to the customer by the business entity including products or services offered to the customer by the business entity, a time that each of the offers was made to the customer, an indication of whether each of the offers was accepted by the customer, and an indication of which of the products or services the customer currently has.

4. The non-transitory computer readable medium of claim 1, wherein the target feature is a customer value to the business entity.

5. The non-transitory computer readable medium of claim 4, wherein the customer value is calculated for each customer profile of the plurality of customer profiles, using a predefined function.

6. The non-transitory computer readable medium of claim 1, wherein generating the map includes:
generating a two-dimensional (2D) map of the plurality of customer profiles based on the one or more non-actionable features and the one or more actionable features,
calculating a value for the target feature for each customer profile of the plurality of customer profiles, and
generating a 3D map by adding the target feature to the 2D map.

7. The non-transitory computer readable medium of claim 6, wherein generating the map further includes:
smoothing the 3D map by using extrapolation to fill in blank points on the 3D map.

8. The non-transitory computer readable medium of claim 1, wherein the map is a four-dimensional map (4D) having a fourth dimension that represents a degree to which leading properties are actionable.

9. The non-transitory computer readable medium of claim 1, wherein the target feature is selected for optimization.

10. The non-transitory computer readable medium of claim 1, further comprising displaying the map in a user interface for viewing by a user.

11. The non-transitory computer readable medium of claim 10, wherein the user interface includes a path tool, and wherein the path is determined from the user manually drawing the path on the map.

12. The non-transitory computer readable medium of claim 11, wherein responsive to the user manually drawing the path on the map, the user interface presents the values for the one or more non-actionable features and the one or more actionable features for the first customer profile and the second customer profile.

13. The non-transitory computer readable medium of claim 10, wherein the user interface includes a point tool for use by the user in selecting a point on the map, and wherein the user interface presents the values for the one or more non-actionable features and the one or more actionable features for a customer profile corresponding to the selected point on the map.

14. The non-transitory computer readable medium of claim 1, wherein the path is determined automatically using an algorithm.

15. The non-transitory computer readable medium of claim 14, wherein the algorithm generates a plurality of potential paths and selects one of the potential paths as the determined path.

16. The non-transitory computer readable medium of claim 15, wherein the one of the potential paths is selected for having a greatest change between the first point and the second point in the dimension representing the target feature with the least distance in another dimension.

17. The non-transitory computer readable medium of claim 1, wherein the value of the at least one actionable feature in the first customer profile is identified as capable of being modified to match a value of the at least one actionable feature in the second customer profile, to optimize the target feature corresponding to the first customer profile based on the second customer profile.

18. The non-transitory computer readable medium of claim 1, further comprising:
determining a probability that the target feature corresponding to the first customer profile will be optimized responsive to modifying the at least one actionable feature of the one or more non-actionable features in the first customer profile.

19. A method, comprising:
accessing customer data that includes a plurality of customer profiles stored for a plurality of customers of a business entity, wherein each customer profile of the plurality of customer profiles includes values for:
one or more non-actionable features that are each a feature that is not capable of being affected by the business entity, and
one or more actionable features that are each a feature that is capable of being affected by the business entity;
generating at least a three-dimensional (3D) map from the customer data, wherein each point on the map represents a different customer profile of the plurality of customer profiles, and wherein at least one dimension of the map represents a target feature; and
determining a path between a first point on the map representing a first customer profile of the plurality of customer profiles and a second point on the map representing a second customer profile of the plurality of customer profiles, for identifying at least one actionable feature of the one or more actionable features in the first customer profile capable of having its value modified to optimize the target feature corresponding to the first customer profile.

20. A system, comprising:
a non-transitory memory storing instructions; and
one or more processors in communication with the non-transitory memory that execute the instructions to perform a method comprising:
accessing customer data that includes a plurality of customer profiles stored for a plurality of customers of a business entity, wherein each customer profile of the plurality of customer profiles includes values for:
one or more non-actionable features that are each a feature that is not capable of being affected by the business entity, and
one or more actionable features that are each a feature that is capable of being affected by the business entity;
generating at least a three-dimensional (3D) map from the customer data, wherein each point on the map represents a different customer profile of the plurality of customer profiles, and wherein at least one dimension of the map represents a target feature; and
determining a path between a first point on the map representing a first customer profile of the plurality of customer profiles and a second point on the map representing a second customer profile of the plurality of customer profiles, for identifying at least one actionable feature of the one or more actionable features in the first customer profile capable of having its value modified to optimize the target feature corresponding to the first customer profile.
